(19) United States
(12) Patent Application Publication
(10) Pub. No.: US 2003/0005035 A1
(43) Pub. Date: Jan. 2, 2003

(54) Peer-to-peer content popularity

(75) Inventor: Peter James Rodgers, Wotton-Under-Edge (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/160,182

(22) Filed: Jun. 4, 2002

(30) Foreign Application Priority Data
Jun. 4, 2001 (GB) 0113568.0

(51) Int. Cl. G06F 15/16

(52) U.S. Cl. 709/202; 709/218; 709/219

(57) ABSTRACT

The invention concerns the provision of a peer-to-peer content popularity service and particularly to a server, methods and computer program products for providing such a service. A server 30 is provided on a peer-to-peer network. The server 30 is arranged to receive data from supplying client nodes 10,20 concerning search requests received at the supplying client nodes 10, 20 and to aggregate material from the received data to obtain popularity information and to offer popularity information regarding such popular search requests to requesting clients 10,20.

The invention relates to a peer-to-peer content popularity service and particularly to a server, methods and computer program products for providing such a service.

In the field of distributed computer networks statistics relating to “popularity” in the broadest sense are extremely important. For instance, it would be desirable to provide statistics which allow access to data concerning the most popular subjects for users of distributed peer-to-peer systems to be utilised in real time by providers of services to tailor their content in order to appeal to the largest number of people. Similarly, if a particular provider of a service knows what a certain section of the browsing community are most interested in, this can help the service provider to target advertising in a most effective way.

A peer-to-peer network is one in which any node on the network may function as a client/server. At the time of writing, common peer-to-peer applications are gnutella and Napster for electronic media and Groove for business collaboration.

Napster enables peer-to-peer file sharing by means of direct TCP/IP port to port connection. In addition metadata and service data are delivered by means of the hypertext transfer protocol (HTTP), the same protocol that web browsers and servers utilise. Effectively, each computer connected to the network acts as a server and as a client. In many cases of course the particular nodes constitute empty repositories (i.e. many users have no files which they themselves wish to share). When an individual user logs off, his or her network node effectively disappears.

As can be seen from the above, a peer-to-peer network has to a large extent a very much more dynamic and transient nature than the world wide web. Nevertheless, such networks do still tend to have a large number of permanently connected client/servers and some form of popularity rating provision would be a useful service to provide to network users.

It is an aim of embodiments of the present invention to provide a peer-to-peer client server and a metadata aggregation service in which popularity ratings may be provided to users of a peer-to-peer network. It is increasingly the case that distributed file-sharing systems will have consistent and robust metadata. Systems such as the digital object identifier (DOI) provide both a unique “bar-code” for a digital file but also offer resolution services to definitive metadata associated with that identifier. An example of a definitive metadata naming scheme is the “Dublin Core” metadata convention.

A metadata aggregation service can record unique attributes such as the DOI and the metadata. Popularity ratings are easily achieved by monitoring a selected unique attribute.

It is another aim of the embodiments of the invention to enable demographic information to be gathered for the client/servers. Metadata concerning the content is augmented by demographic data associated with the peer to peer client server. By gathering demographic data it is possible to offer fine grained classifications of popularity by geography, sex, age, interest etc.

According to a first aspect of the invention, there is provided aserver on a peer-to-peer network, the server being arranged to receive data from supplying client nodes concerning search requests received at the supplying client nodes, the server being arranged to aggregate material from the received data to obtain popularity information and to offer popularity information regarding popular search requests to requesting clients. According to a second aspect of the invention, there is provided a method of providing popularity information to requesting clients on a peer-to-peer network, the method comprising: at a client node in the network, collecting data concerning search requests received at the client node from another one or more nodes in the peer-to-peer network; and sending data relating to the received search requests to aserver.

A third aspect provides a computer program product for use at a client node in a peer-to-peer network for facilitating the implementation of a method of providing popularity information to requesting clients on the peer-to-peer network, the method comprising: at the client node, collecting data concerning search requests received from another one or more nodes in the peer-to-peer network; and sending data relating to the received search requests to a server.

In a fourth aspect, there is provided a method of providing popularity information to requesting clients on a peer-to-peer network, the method comprising: at a server receiving data from supplying client nodes concerning search requests received at the supplying client nodes; aggregating material from the received data at the server to obtain popularity information; and offering popularity information regarding popular search requests to a requesting client.

In a fifth aspect, there is provided a computer program product for use at a server in a peer-to-peer network for facilitating the implementation of a method of providing popularity information to requesting clients on the peer-to-peer network, the method comprising: receiving data from supplying client nodes concerning search requests received at the supplying client nodes; aggregating material from the received data at the server to obtain popularity information; and offering popularity information regarding popular search requests to a requesting client.

The received data preferably is metadata relating to the search requests and/or demographic data relating to parties making the particular search requests.

The popularity information may comprise information concerning most popular search topics. Popularity information may be requested and supplied for particular file types, for instance, music files. Popularity information may be provided based on user demographics.

The server is preferably arranged to offer the popularity information to subscribing clients only.

Preferably, supplying clients cache peer-to-peer search requests and periodically send lists of fulfilled search requests to the server.

Preferably, data is transferred between a supplying client and the server by means of a document, such as an XML document.

Preferably, upon receipt of the document from a supplying client, the server aggregates metadata within the document to create lists according to the metadata. Such a list may comprise a list of most popular files, a listing of the timings that those most popular files were requested, and regional/demographic data provided from the client.

Preferably, the server creates lists according to a unique digital object identifier. The DOI can be used to resolve definitive metadata such as Dublin Core metadata for the object and this metadata may be compiled into the lists.

Alternatively the lists may be inferred from file types, such file types may comprise music files, movie files, picture files, document files, etc. Classification of file types may be by means of examining a file extension.

Subscribing clients may have one of a number of different types of subscription according to service levels.

Preferably, subscribing clients pay a subscription fee to the server in order to have access to information from the server.

For a better understanding of the invention, and to show how embodiments of the same may be carried into effect, reference will now be made, by way of example, to the following figures, in which:

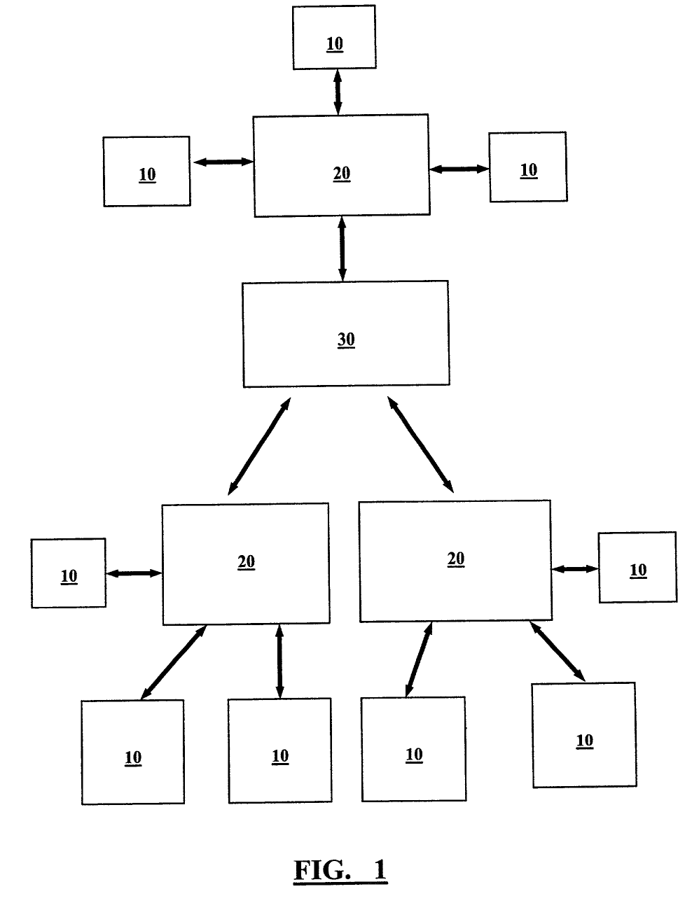

FIG. 1 is a schematic block diagram illustrating a peer-to-peer client/server network including a popularity server according to an embodiment of the present invention;

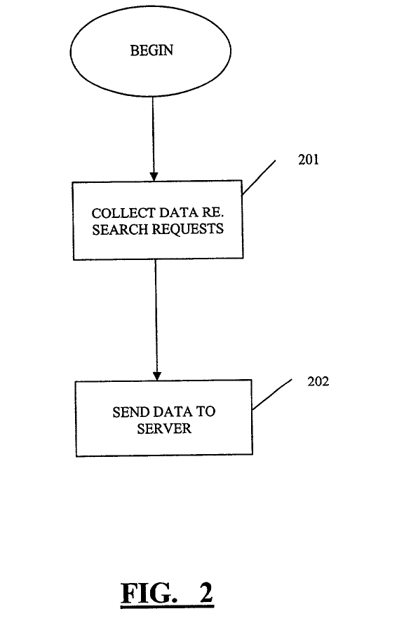

FIG. 2 is a flow diagram illustrating method steps carried out at a client node for collecting and sending data to a server; and

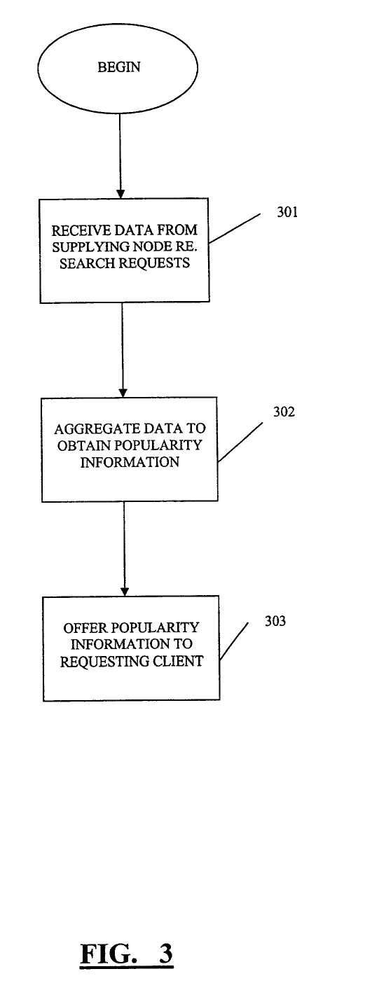

FIG. 3 is a flow diagram illustrating method steps carried out at the server for processing popularity data and offering such information to requesting clients.

Referring to FIG. 1, there is shown a peer-to-peer network comprising a plurality of nodes consisting of first type client/servers 10, second type client/servers 20 and a popularity server 30.

In FIG. 1, it will be appreciated that although certain connections are shown between selected nodes of the network (a node being any of the first type client/servers 10 or second type client/servers 20) in reality, individual first type client/servers 10 can communicate directly with each other and with the popularity server 30 without a connection via second type client/servers and, indeed, individual second type client/servers may also communicate directly with each other. However, as, in practice, certain nodes (here identified as the second type client/servers 20) within a peer-to-peer network tend to primarily function in a server type role, a simplified representation of the possible connections is shown. This simplification is merely to aid clarity in the description of the invention and to avoid cluttering the Figure.

Typically, each first type client/server 10 may be an individual user's machine, such as a PC. The second type client/servers 20 (also referred to as file location servers) provide information to the individual first type client/servers 10 in response to search requests from individual first type client/servers 10. The second type client/servers 20 may facilitate direct connections between individual first type client/servers 10 for the sharing of information.

Since it is a primary function of the second type client/servers 20 to fulfil search requests made by individual first type clients/servers 10, it is a relatively simple matter for individual second type client/servers 20 to cache the most popular search requests and most popular fulfilled search requests and to pass them periodically to the popularity server 30. Such requests may be passed to the popularity server 30, by means of a document, typically an XML document, constructed at each server 20. Alternatively, it is possible for the popularity server 30 to poll individual servers 20 and request, at periodic intervals, information on search requests fulfilled.

The popularity server 30 upon receiving information from the second type client/servers 20 concerning requests fulfilled, sorts and catalogues the metadata of the search requests according to various different criteria. For instance: lists of most popular files and the times the files were requested may be compiled; data may be categorised according to regional and demographic user data; file types may be classified as either music, movies etc., by resolution of a unique ID or by examining file extensions.

It will be appreciated that the above list is not exhaustive and that data regarding search requests may be catalogued in any number of different ways to facilitate retrieval of popularity ratings. For instance, if a particular client is interested in receiving popularity information concerning the top ten searches made by 30 to 40 year olds in connection with jazz music, the popularity server 30 may be arranged to sort among the data provided to it by individual servers 20 and to provide the requested information to a requesting client. Here, the term client is used loosely as it refers to any client of the popularity server 30 and hence applies to the second type client/servers 20 who themselves are “clients” of the popularity server 30 and also applies to first type client/servers 10 (which may typically be a user's PC for instance).

The popularity server 30 may store the popularity data in a number of different ways. For recent histories of the peer to peer network it will store all data and compute popularity lists on demand, e.g. the top 1000 songs by artist currently being shared.

Recent histories require very large amounts of data to be stored, it is expected that to minimise computation it will be valuable to create longer period historical data generated in common categories, e.g. most popular rock music for the week of Apr. 23, 2001. Longer period charts are valuable for premium rate popularity services.

Individual clients of the popularity server 30 may subscribe to the popularity server 30 according to a number of different possible service levels. Here, the service levels are described as bronze, silver and gold.

In a first, bronze, level of service a bronze client simply receives aggregated search metadata relating to its particular place in the peer-to-peer network. In other words, a bronze client is able to obtain information concerning the search requests which it itself serves, but receives that information in an organised fashion from the popularity server 30. Such data may give a global view on what is happening on the network and provide some real time search information to the client.

In a second, silver, level of service, all of the information provided to bronze clients would be provided, in addition further information perhaps relating to demographic user data etc., can be provided. Silver clients will, in other words, have more options for the types of chart information that they can request and receive from the popularity server 30.

In a highest level of service, a gold client may pay a monthly fee to access additional metadata to make “rich” requests of the server (for instance, “what were the most popular songs in California in February 2000?”). The popularity server 30 can provide lists of most capable nodes to add to a local peer-to-peer network, thereby aiding efficiency of search and retrieval carried out by its gold level clients. In this way, a gold client could perhaps ask the popularity server to provide it with details of a node on a peer-to-peer network having a given file. With such information available to it, such a client can search additional ID3 metadata (albums, artists, etc.) and view most popular songs, movies, etc.

The popularity server 30 given enough information can compile lists to answer relatively complex requests from clients. For instance, a complex request might ask for lists of files downloaded by third parties who had already downloaded some particular other file. It will be appreciated here that the state of a peer-to-peer network is dynamic and that embodiments of the invention provide a real time view of this state to enable monitoring and demand mangement (such as the subsequent provision of heavily sought content at new nodes) and to enable the location of files regardless of the dynamic state of the network.

A specific example of how the metadata aggregation and how a popularity request may be fulfilled in practice is given hereafter.

Referring to FIG. 2, in simple terms, actions carried out at a client node 10 or 20 comprise a first step 201 of collecting data concerning search requests received at the client node from another one or more nodes in the peer-to-peer network and then in a step 202 sending data relating to the search requests to the popularity server 30.

Referring to FIG. 3, in simple terms the actions carried out at the popularity server 30 comprise: a first step 301 of receiving data from supplying client nodes 10,20 concerning search requests received at the client nodes 10,20; a second step 302 of aggregating material from the received data at the server to obtain popularity information; and a third step 303 of offering popularity information regarding popular search requests to a requesting client 10,20.

In the more detailed discussion of one example of implementation of the method which follows it is assumed that a particular first type client/server is a subscriber to the service and the interactions between this client 10 and the popularity server 30 are described in detail. A first type client/server 10 of the peer-to-peer network maintains a local table A of it's most recently fulfilled file transfers. In an efficient network the second type client/servers 20 (file location servers) will maintain a directory of DOI and metadata such that the list of fulfilled file transfers on client 10 may be stored as a list of globally unique (to the service) identifiers with an associated count (x) of fulfilled file transfers:

A. local popularity list [DOI₁:x . . . DOI_{N}:z]

B. local demographic info Sex: xxx yyy Age: xx Geographic Region: New York Interests: aaaa, bbbb, cccc, . . . , zzz

The client 10 periodically posts the local popularity list A and it's corresponding local demographic information B and a UTC timestamp to the popularity server 30 and, upon receiving an acknowledgement, begins compilation of a new list. In times of very large numbers of peers on the network the server 30 may negotiate with the aggregation client 10 to supply only the most popular subset of the list, thereby reducing the load on popularity server 30. In addition, if the client 10 has a low file serving history (as indicated by the list A) the popularity server 30 may instruct client 10 to increase the time between postings and thus lower the load for popularity server 30 and ensure the high use nodes on the network can deliver their popularity data in a timely manner.

It is preferable that the demographic data be composed of system-wide common codes, for example Jazz might be coded as M245, whereas region NewYork may be coded as R1032. It is preferable that the codes stored in the demographic table of client 10 can have been pre-computed at the time of logon to the second type client/server 20.

The popularity server 30 receives many popularity and demographic lists A:B from the clients of the network. The popularity server 30 maintains popularity tables. These tables may be structured in a number ways based upon breadth of search or storage and computation constraints. One such configuration is as follows . . .

TABLE 1

Objects
DOI: [Standard Dublin Core Metadata . . . Fields]: 5 mins: 1 hour
: 1 day: 1 week: 1 year

TABLE 2

Region
Region Code: [DOI: x list . . . ]
. . .

In this example the popularity server 30 takes a local popularity list A:B and in turn extracts each DOI, it's popularity count x, and the demographic codes from B. The aggregator locates the DOI entry in the Objects table, table 1. It adds the count x to each of the time fields, 5mins . . . 1year. It is expected that periodically the counters will be reset or, more elaborately, a rolling average can be computed for each field. Finally the aggregator service examines the region code and adds x to the corresponding DOI entry in the Region table, table 2. Thus we have described a very simple global popularity table. This scheme is illustrative and can be adapted in many ways, for example further demographic sub-tables would certainly be valuable.

The final element of the system is the processing of popularity requests. For example, a client 10 of the popularity server 30 wishes to find the most popular Jazz music in New York today. It sends a request which can be coded using the common encoding formats described above thus the request might be

Request: M245:R1032:T3

Where the codes are M245 Jazz, R1032 New York and T3 is the coding for the last 24hours.

From this request the popularity server 30 may then consult the tables retrieving the list of all DOI's served in the New York region. Next the popularity server 30 computes a Jazz popularity table by taking the DOI list and matching it against the Jazz field in the Dublin core metadata and extracting the DOI, Dublin core metadata and 1day count for each matching entry. Finally the computed popularity table is sorted by the 1 day count and served back to the client.

It will be appreciated by the skilled man that the invention may be efficiently implemented by means of computer program products embodying the methods described and loaded at the popularity server 30 and at the client nodes 10, 20.

It will be evident to the skilled man, that many variations can be made within the scope of this invention and that such scope is limited only by the appended claims.

1. A server on a peer-to-peer network, the server being arranged to receive data from supplying client nodes concerning search requests received at the supplying client nodes, the server being arranged to aggregate material from the received data to obtain popularity information and to offer popularity information regarding such popular search requests to requesting clients.

2. The server of claim 1 wherein the received data is metadata relating to the search requests and/or demographic data relating to parties making the search requests.

3. The server of claim 1, where the popularity information comprises information concerning most popular search topics requested at client level.

4. The server of claim 1, wherein popularity information may be requested from the server by clients and supplied according to particular client requested criteria.

5. The server of claim 1, wherein the server is arranged to offer the popularity information to subscribing clients only.

6. A server of claim 5, wherein subscribing clients may have one of a number of different types of subscription according to service levels.

7. A server according to claim 6, wherein subscribing clients pay a subscription fee to the server in order to have access to information from the server.

8. The server of claim 1, wherein supplying client nodes cache peer-to-peer search requests and periodically send lists of fulfilled search requests to the server.

9. The server of claim 1, wherein data is transferred between a supplying client node and the server by means of a document.

10. The server of claim 10, wherein upon receipt of a document from a supplying client, the server aggregates metadata within the document to create lists according to the metadata.

11. The server of claim 10, wherein such a list may comprise a list of most popular files, a listing of the timings that those most popular files were requested, and regional/demographic data provided from the client.

12. A server according to claim 10, wherein the server creates lists classified according to a unique identifier and its associated Dublin Core metadata.

13. A server according to claim 10, wherein the server creates lists classified according to file types, such file types may comprise music files, movie files, picture files, document files, etc.

14. A server according to claim 12, wherein classification of file types is achieved by means of examining a file extension.

15. A method of providing popularity information to requesting clients on a peer-to-peer network, the method comprising:
at a client node in the network, collecting data concerning search requests received at the client node from another one or more nodes in the peer-to-peer network; and
sending data relating to the received search requests to a server.

16. The method of claim 15, wherein the data sent by the client node to the server comprises metadata relating to the search requests and/or demographic data relating to parties making the search requests.

17. The method of claim 15, wherein the client node is arranged to cache peer-to-peer search requests and periodically send lists of fulfilled search requests to the server.

18. The method of claim 15, wherein data is transferred between a supplying client node and the server by means of a document.

19. The method of claim 15, wherein the data sent by the client node to the server comprises metadata relating to search requests fulfilled at the client node.

20. A computer program product for use at a client node in a peer-to-peer network for facilitating the implementation of a method of providing popularity information to requesting clients on the peer-to-peer network, the method comprising:
at the client node, collecting data concerning search requests received from another one or more nodes in the peer-to-peer network; and
sending data relating to the received search requests to a server.

21. The computer program product of claim 20, wherein when running the program is arranged to enable the monitoring of search requests made to the client node by other nodes on the network and to store metadata relating to the search requests and/or demographic data relating to parties making the search requests.

22. The computer program product of claim 21, wherein when running the program is arranged to enable the caching of peer-to-peer search requests and the transmission of lists of fulfilled search requests to the server.

23. The computer program product of claim 20, wherein data is transferred between a supplying client node and the server by means of a document.

24. The computer program product of claim 20, wherein the data sent by the client node to the server comprises metadata relating to search requests fulfilled at the client node.

25. A method of providing popularity information to requesting clients on a peer-to-peer network, the method comprising:
at a server receiving data from supplying client nodes concerning search requests received at the supplying client nodes;
aggregating material from the received data at the server to obtain popularity information; and
offering popularity information regarding popular search requests to a requesting client.

26. The method of claim 25, wherein the received data is metadata relating to the search requests and/or demographic data relating to parties making the search requests.

27. The method of claim 25, where the popularity information comprises information concerning most popular search topics requested at client level.

28. The method of claim 25, wherein popularity information may be requested from the server by clients and supplied according to particular client requested criteria.

29. The method of claim 25, wherein the server is arranged to offer the popularity information to subscribing clients only.

30. The method according to claim 29, wherein subscribing clients may have one of a number of different types of subscription according to service levels.

31. The method according to claim 30, wherein subscribing clients pay a subscription fee to the server in order to have access to information from the server.

32. The method of claim 25, wherein supplying client nodes cache peer-to-peer search requests and periodically send lists of fulfilled search requests to the server.

33. The method of claim 25, wherein data is transferred between a supplying client node and the server by means of a document.

34. The method of claim 33, wherein upon receipt of a document from a supplying client, the server aggregates metadata within the document to create lists according to the metadata.

35. The method of claim 34, wherein such a list may comprise a list of most popular files, a listing of the timings that those most popular files were requested, and regional/demographic data provided from the client.

36. The method according to claim 25, wherein the server creates lists classified according to a unique identifier and its associated Dublin Core metadata.

37. The method according to claim 25, wherein the server creates lists classified according to file types, such file types may comprise music files, movie files, picture files, document files, etc.

38. The method according to claim 25, wherein classification of file types is achieved by means of examining a file extension.

39. A computer program product for use at a server in a peer-to-peer network for facilitating the implementation of a method of providing popularity information to requesting clients on the peer-to-peer network, the method comprising:
receiving data from supplying client nodes concerning search requests received at the supplying client nodes;
aggregating material from the received data at the server to obtain popularity information; and
offering popularity information regarding popular search requests to a requesting client.

40. The program product of claim 39, wherein the received data is metadata relating to the search requests and/or demographic data relating to parties making the search requests.

41. The program product of claim 39, wherein the popularity information comprises information concerning most popular search topics requested at client level.

42. The program product of claim 39, wherein popularity information may be requested from the server by clients and supplied according to particular client requested criteria.

43. The program product of claim 42, wherein the server is arranged to offer the popularity information to subscribing clients only.

44. The program product of claim 43, wherein subscribing clients may have one of a number of different types of subscription according to service levels.

45. The program product of claim 39, wherein periodically lists of fulfilled search requests are sent to the server by supplying client nodes.

46. The program product of claim 39, wherein data is received at the server from a supplying client node in the form of a document.

47. The program product of claim 46, wherein in the step of aggregating the server aggregates metadata within the document to create lists according to the metadata.

48. The program product of claim 39, wherein in the step of aggregating the server creates lists of most popular files, a listing of the timings that those most popular files were requested, and regional/demographic data provided from the supplying client.

49. The program product of claim 39, wherein in the step of aggregating the server creates lists classified according to a unique identifier and its associated Dublin Core metadata.

50. The program product of claim 39, wherein in the step of aggregating the server creates lists classified according to file types, such file types may comprise music files, movie files, picture files, document files, etc.

51. The program product of claim 50, wherein classification of file types is achieved by means of examining a file extension.

52. A server on a peer-to-peer network, the server being arranged to receive data from supplying client nodes comprising metadata relating to search requests received at the client nodes and/or demographic data relating to parties making the search requests, the server being arranged to aggregate material from the received data to obtain popularity information and to offer popularity information regarding most popular search topics requested at client level to requesting clients according to particular client requested criteria.

53. A method of providing popularity information to requesting clients on a peer-to-peer network, the method comprising:
at a client node in the network, collecting data concerning search requests received at the client node from another one or more nodes in the peer-to-peer network; and
sending data relating to the received search requests to a server, wherein the data sent by the client node to the server comprises metadata relating to the search requests and/or demographic data relating to parties making the search requests.

54. A computer program product for use at a client node in a peer-to-peer network for facilitating the implementation of a method of providing popularity information to requesting clients on the peer-to-peer network, the method comprising:
at the client node, collecting data concerning search requests received from another one or more nodes in the peer-to-peer network; and
sending data relating to the received search requests to a server, wherein when running the program is arranged to enable the monitoring of search requests made to the client node by other nodes on the network and to store metadata relating to the search requests and/or demographic data relating to parties making the search requests.

55. A method of providing popularity information to requesting clients on a peer-to-peer network, the method comprising:
at a server receiving data from supplying client nodes concerning search requests received at the supplying client nodes, the received data comprising metadata relating to the search requests and/or demographic data relating to parties making the search requests;
aggregating material from the received data at the server to obtain popularity information which comprises information concerning most popular search topics requested at client level; and
offering popularity information regarding popular search requests to a requesting client according to particular client requested criteria.

56. A computer program product for use at a server in a peer-to-peer network for facilitating the implementation of a method of providing popularity information to requesting clients on the peer-to-peer network, the method comprising:
receiving data from supplying client nodes concerning search requests received at the supplying client nodes, wherein the received data is metadata relating to the search requests and/or demographic data relating to parties making the search requests;
aggregating material from the received data at the server to obtain popularity information, wherein the popularity information comprises information concerning most popular search topics requested at client level; and
offering popularity information regarding popular search requests to a requesting client and supplying such information according to particular client requested criteria.
